(19) United States
(12) Patent Application Publication
(10) Pub. No.: US 2026/0077889 A1
(43) Pub. Date: Mar. 19, 2026

(54) BOXING MACHINE AND METHOD FOR BOXING PRODUCTS

(71) Applicant: Fameccanica.Data S.p.A., San Giovanni Teatino Chieti (IT)

(72) Inventors: Antonio GIANSANTE, San Giovanni Teatino Chieti (IT); Dario GALANTE, San Giovanni Teatino Chieti (IT)

(21) Appl. No.: 19/332,593

(22) Filed: Sep. 18, 2025

(30) Foreign Application Priority Data
Sep. 19, 2024 (IT) 102024000020956

(51) Int. Cl. B65B 5/06; B25J 9/16; B25J 11/00; B65B 35/36; B65B 35/44

(52) U.S. Cl. CPC B65B 5/06; B25J 9/1697; B25J 11/005; B65B 35/36; B65B 35/44

(57) ABSTRACT

A boxing machine for boxing products, including a group conveyor, configured to transfer product groups from a group forming section to a boxing section along a group transport direction, wherein the group conveyor comprises includes a lower belt and a side belt movable along the group transport direction, and wherein a distance between the side belt and a distal edge of the lower belt is adjustable as a function of a predetermined width of the product groups to be formed.

### FIELD OF THE INVENTION

The present invention relates to a boxing machine and a method for boxing products.

The invention was developed in particular for the application in the production of absorbent sanitary articles, for example for boxing packages of absorbent sanitary articles enclosed in bags coming from a production line.

However, the invention is not limited to this specific field and can be used in all cases where it is necessary to box products at the end of a production line.

### PRIOR ART

Systems for boxing products at the end of a production line represent a crucial element in industrial automation. These systems, often equipped with advanced robotic technology, are designed to ensure efficiency and precision in product packaging. Using automatic handling units equipped with anthropomorphic robots or similar, these systems can handle a wide range of product sizes and types, adapting to the specific needs of each customer. Customization is a fundamental aspect, allowing the systems to be configured to handle variable production volumes and optimally respond to market dynamics. The efficiency of these systems translates into a significant improvement in productivity and the ability to quickly respond to changes in production needs.

These systems use robotic boxing machines designed and built to allow the vertical filling of boxes with previously formed product groups, wherein the products within the groups are arranged with a predetermined orientation determined to optimally exploit the volume of the boxes.

A boxing machine may include: a group conveyor, a first robotic unit configured to form product groups on the group conveyor, and a second robotic unit to pick up product groups from the group conveyor and insert the product groups into respective boxes. An example of a robotic boxing machine is described in EP2096035A1.

The speed of the product loading robots is crucial for the efficiency of boxing machines, as it determines how quickly the products can be processed and boxed. A fast loading robot can significantly increase the throughput of a production line, reducing downtime and maximizing resource utilization.

Cycle time optimization is essential to increase the speed and efficiency of a loading robot. This process involves analyzing and standardizing the various operational phases, allowing for the reduction of dead times and increased productivity. A reduction in time waste in the work cycle considerably improves the robot's speed without compromising system reliability. Therefore, the optimization of loading robot movements is an important factor in increasing the throughput of a boxing line. The optimization of robot movements is particularly important during changes in the format of the packages processed by the boxing machine.

### OBJECT AND SUMMARY OF THE INVENTION

The object of the present invention is to provide a boxing machine and a method for boxing products that allow optimizing the throughput of a boxing machine, particularly when changing the format of the packages processed by the boxing machine.

In particular, the object of the present invention is to increase the efficiency of a boxing machine by optimizing cycle times and reducing unproductive movements of a loading robot.

According to the present invention, this object is achieved by a boxing machine having the features forming the subject of claim 1.

According to another aspect, the invention relates to a method for boxing products having the features forming the subject of claim 6.

Preferred embodiments of the invention form the subject of the dependent claims.

The claims form an integral part of the teaching provided in relation to the invention.

### BRIEF DESCRIPTION OF THE DRAWINGS

The present invention will now be described in detail with reference to the accompanying drawings, provided solely by way of non-limiting example, in which:

FIG. 1 is a schematic plan view of an embodiment of a system for boxing products,

FIG. 2 is a schematic perspective view of some parts of a boxing machine according to the present invention, and

FIGS. 3, 4, and 5 are schematic cross-sections along line III-III of FIG. 2.

It will be appreciated that the accompanying drawings are schematic and that some components may not be illustrated to simplify the understanding of the figures.

### DETAILED DESCRIPTION

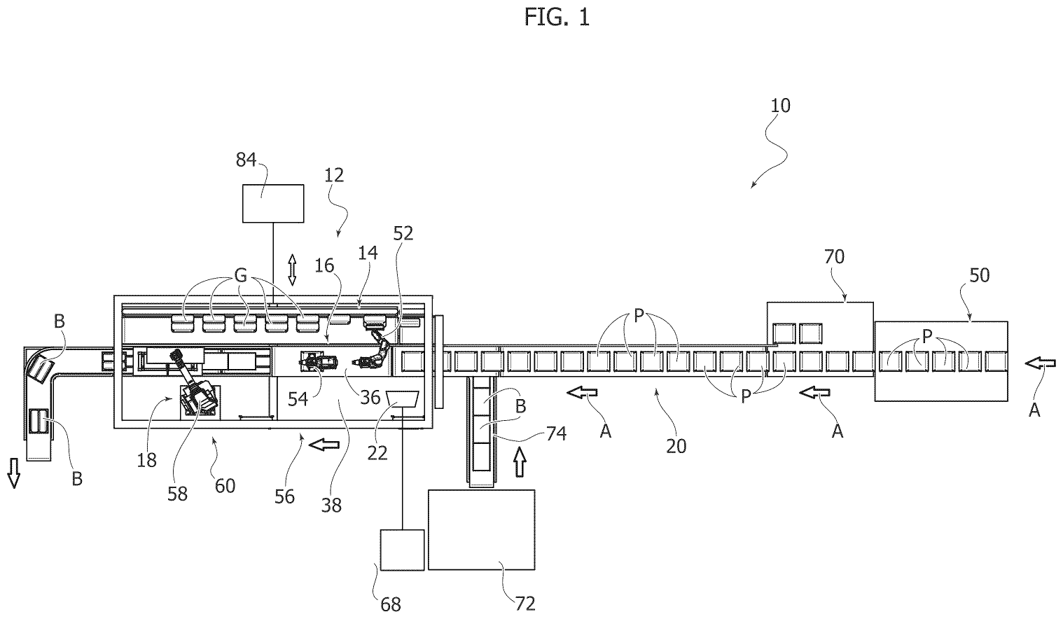

With reference to FIGS. 1, 10 indicates a system for boxing products P coming from the output of a production line 50. The products P may be, for example, packages of absorbent sanitary articles enclosed in flexible bags.

The system 10 includes a boxing machine 12 configured to form product groups G and to insert such product groups G into respective boxes B.

The system 10 includes a main feed conveyor 20 that transfers the products P from the output of the production line 50 to the boxing machine 12. On the main feed conveyor 20, the products P are aligned with each other in a transport direction A and form a row in which the products P are spaced apart from each other in the transport direction A by a constant distance.

The system 10 may include a buffer 70 for accumulating products P. The buffer 70 can accumulate products P coming from the production line 50 during slowdowns or temporary stops of the boxing machine 12. The products P accumulated in the buffer 70 can be used to fill gaps in the row of products advancing on the main feed conveyor 20, as described in Italian patent application No. 102024000011542 by the same Applicant.

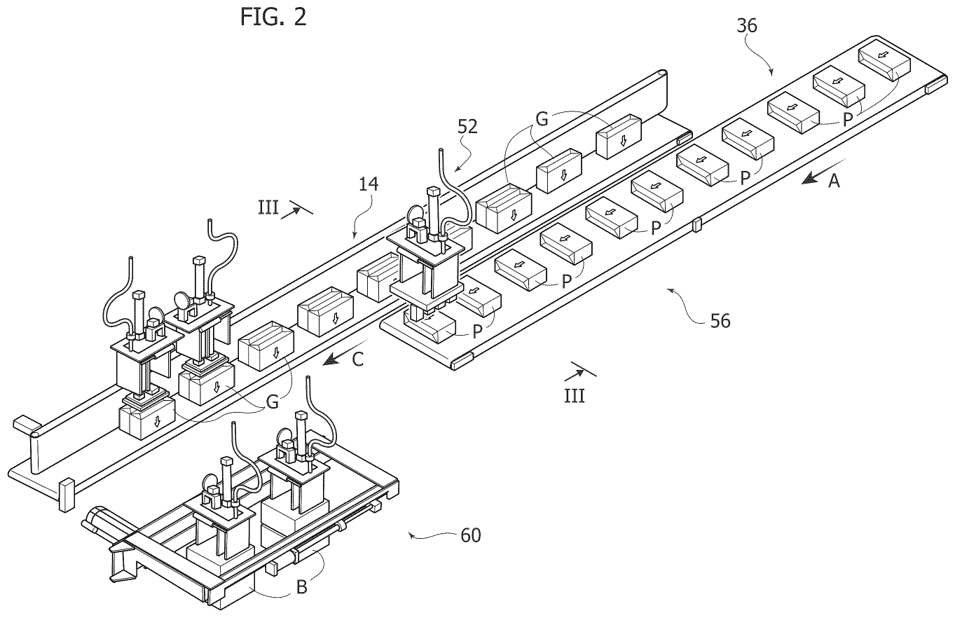

With reference to FIGS. 1 and 2, the boxing machine 12 includes an input conveyor 36 configured to advance a row of products P aligned with each other in a transport direction A.

The boxing machine 12 includes a group forming section 56, a boxing section 60, and a group conveyor 14 configured to transfer product groups G from the group forming section 56 to the boxing section 60 along a group transport direction C. The group transport direction C may be parallel to the transport direction A.

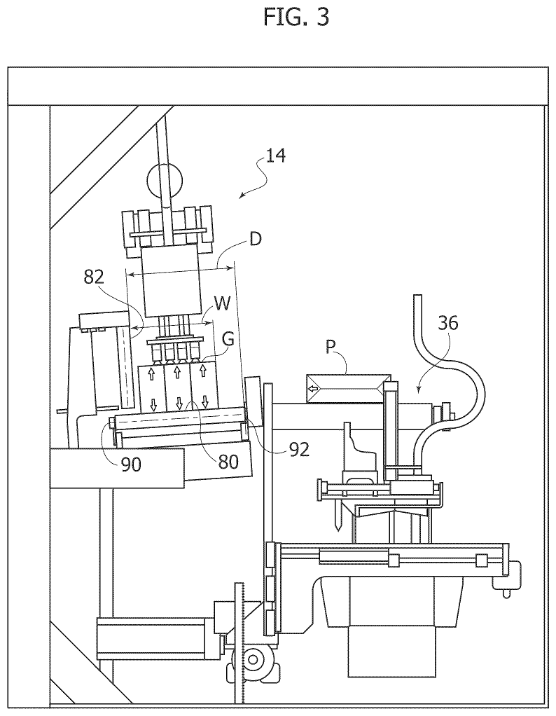

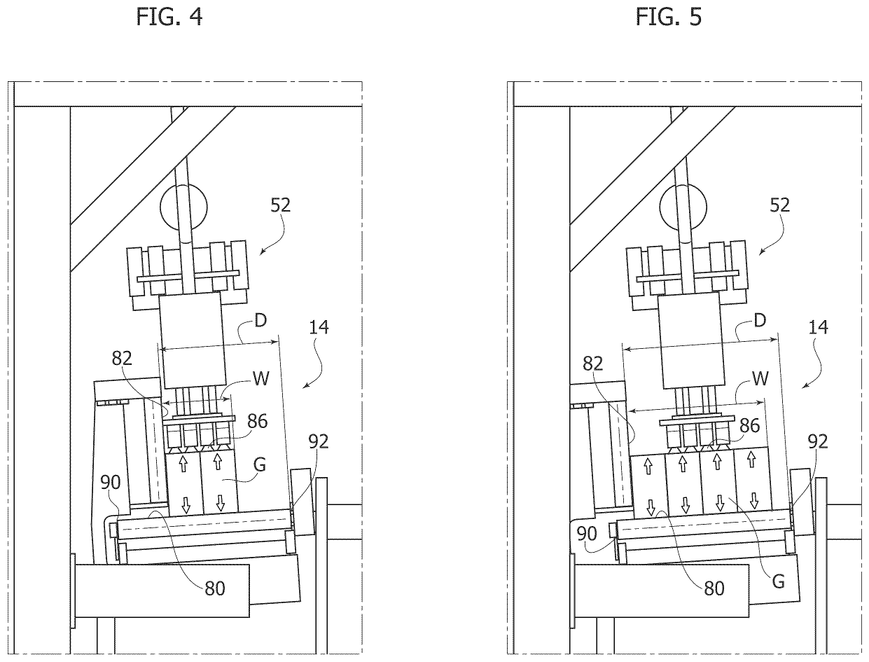

With reference to FIG. 1, the boxing machine 12 includes a first robotic unit 16 located in the group forming section 56 and configured to pick up products P from the input conveyor 36 and to deposit the products P picked up from the input conveyor 36 onto the group conveyor 14. With reference to FIGS. 3-5, the first robotic unit 16 is controlled to form on the group conveyor 14 product groups G having a predetermined width W in a direction orthogonal to the group transport direction C.

The boxing machine 12 includes a second robotic unit 18 configured to pick up product groups G from the group conveyor 14 and insert the product groups G into respective boxes B.

With reference to FIG. 1, the system 10 may include a box forming machine 72 that forms boxes B starting from cardboard blanks. The boxes B are transferred from the box forming machine 72 to the boxing machine 12 via a box conveyor 74 that feeds the boxes B to the boxing section 60. In the boxing section 60, the second robotic unit 18 picks up the product groups G from the group conveyor 14 and inserts the product groups G into the boxes B. When the boxes B are full, the box conveyor 74 transports the boxes B outside the boxing machine 12 and sends them to a closing machine. Advantageously, the box conveyor 74 extends below the input conveyor 36, so that the boxes B during transfer to the boxing section 60 do not obstruct the working area of the first robotic unit 16.

With reference to FIGS. 3-5, the group conveyor 14 includes a lower belt 80 and a side belt 82 movable along the group transport direction C. The lower belt 80 has a proximal edge 90 and a distal edge 92 relative to the side belt 82. A distance D between the side belt 82 and the distal edge 92 in a direction orthogonal to the group transport direction C is adjustable based on the predetermined width W of the product groups G to be formed.

With reference to FIG. 1, in one embodiment the boxing machine 12 may include an actuator group 84 configured to vary the distance D between the side belt 82 and the distal edge 92 of the lower belt 80 and a control unit 68 configured to actuate the actuator group 84 to set the distance D to a value corresponding to a predetermined width W of the product groups G to be formed.

With reference to FIGS. 3-5, in one embodiment the side belt 82 may be orthogonal to the lower belt 80.

In one embodiment, in a section orthogonal to the group transport direction C, the lower belt 80 may be inclined relative to a horizontal plane and the proximal edge 90 may be lower than the distal edge 92.

In one embodiment, the first robotic unit 16 may include at least one anthropomorphic robot 52 equipped with a suction gripping device 86. In the example illustrated in FIG. 1, the first robotic unit 16 includes two anthropomorphic robots 52, 54, both controlled by the electronic control unit 68 to pick up products P from the input conveyor 36 and to deposit the products P picked up from the input conveyor 36 onto the group conveyor 14 to form on the group conveyor 14 product groups G having a predetermined width W in a direction orthogonal to the group transport direction C.

With reference to FIG. 1, the boxing machine 12 may include a vision device 22 configured to visually inspect a part of the row of products on the input conveyor 36 and to send to the electronic control unit 68 information about the position of the products P. The electronic control unit 68 may be configured to command the anthropomorphic robots 52, 54 based on the information provided by the vision device 22. The vision device 22 may be disposed in a stationary position in the group forming section 56 of the boxing machine 12 or may be disposed on the head of one or both of the anthropomorphic robots 52, 54 located in the group forming section 56 of the boxing machine 12.

In operation, the first robotic unit 16 picks up successive products P located on the input conveyor 36 and deposits them with a predetermined orientation on the group conveyor 14 to form successive product groups G. The pick-and-place cycle involves depositing the first product P of each product group G to be formed with a base face resting on the lower belt 80 and a side face resting against the side belt 82. The subsequent products P of each product group G to be formed are arranged with a base face resting on the lower belt 80 and a side face resting against a side face of a previously deposited product P. The pick-and-place cycle repeats until a product group G is formed consisting of a predetermined number of products P and with a predetermined width W. The product groups G being formed continuously advance along the group conveyor 14.

FIGS. 3-5 show different positions of the side belt 82 in cases where the product groups G are formed respectively by three, two, and four products P.

The fact that the distance D between the side belt 82 and the distal edge 92 of the lower belt 80 is adjustable based on the predetermined width W of the product groups G to be formed allows reducing the travel amplitudes of the gripping devices 86 of the anthropomorphic robots 52, 54 during each pick-and-place cycle of products.

This allows increasing the speed of the product loading robots and, consequently, the efficiency of the boxing machine as it determines how quickly the products can be processed and boxed.

The higher speed of the loading robots can significantly increase the throughput of the boxing machine, reducing downtime and maximizing resource utilization.

The boxing machine 12 previously described in operation implements a method for boxing products P, comprising:
advancing a row of products P aligned with each other in a transport direction A along an input conveyor 36,
picking up products P from the input conveyor 36 by a first robotic unit 16 and depositing the products P picked up from the input conveyor 36 onto a group conveyor 14 having a lower belt 80 and a side belt 82 movable along a group transport direction C, and forming on the group conveyor 14 product groups G having a predetermined width W,
transferring product groups G from a group forming section 56 to a boxing section 60 along the group transport direction C,
picking up product groups G from the group conveyor 14 by a second robotic unit 18 and inserting the product groups G into respective boxes B, and
adjusting a distance D between the side belt 82 and a distal edge 92 of the lower belt 80 along a direction orthogonal to the group transport direction C as a function of the predetermined width W of the product groups G to be formed.

In one embodiment, the method may comprise providing an actuator group 84 configured to vary said distance D and controlling the actuator group 84 by a control unit 68 configured to set said distance D to a value corresponding to a predetermined width W of the product groups G to be formed.

In one embodiment, the method may provide that the side belt 82 is orthogonal to the lower belt 80.

In one embodiment, the method may provide that in a section orthogonal to the group transport direction C the lower belt 80 is inclined relative to a horizontal plane and that the proximal edge 90 is lower than the distal edge 92.

In one embodiment, the method may comprise visually inspecting a part of the row of products on the input conveyor 36 by a vision device 22, and controlling the first robotic unit 16 based on information provided by the vision device 22.

Naturally, while maintaining the principle of the invention, the construction details and embodiments may be widely varied without thereby departing from the scope of the invention as defined by the claims that follow.

1. A boxing machine for boxing products, comprising:
an input conveyor configured to advance a row of products aligned with each other in a transport direction,
a group forming section,
a boxing section,
a group conveyor, configured to transfer product groups from the group forming section to the boxing section along a group transport direction,
a first robotic unit located in the group forming section and configured to pick up products from said input conveyor and to deposit the products picked up from the input conveyor onto the group conveyor to form, on the group conveyor, the product groups having a predetermined width in a direction orthogonal to the group transport direction, and
a second robotic unit configured to pick up the product groups from said group conveyor and insert said product groups into respective boxes,
wherein said group conveyor comprises a lower belt and a side belt movable along said group transport direction, wherein the lower belt has a proximal edge and a distal edge relative to said side belt, and wherein a distance between the side belt and said distal edge in a direction orthogonal to said group transport direction is adjustable as a function of the predetermined width of product groups to be formed on the group conveyor.

2. The machine of claim 1, comprising an actuator group configured to vary said distance and a control unit configured to actuate said actuator group to set said distance to a value corresponding to the predetermined width of product groups to be formed on the group conveyor.

3. The machine of claim 1, wherein said side belt is orthogonal to said lower belt.

4. The machine of claim 1, wherein in a section orthogonal to said group transport direction said lower belt is inclined relative to a horizontal plane and wherein said proximal edge is lower than said distal edge.

5. The machine of claim 1, comprising a vision device configured to visually inspect a part of the row of products on said input conveyor, and an electronic control unit configured to control said first robotic unit based on information provided by the vision device.

6. A method for boxing products, comprising:
advancing a row of products aligned with each other in a transport direction along an input conveyor,
picking up products from said input conveyor by a first robotic unit and depositing the products picked up from the input conveyor onto a group conveyor having a lower belt and a side belt movable along a group transport direction, and forming, on the group conveyor, product groups having a predetermined width,
transferring the product groups from a group forming section to a boxing section along said group transport direction,
picking up the product groups from said group conveyor by a second robotic unit and inserting said product groups into respective boxes, and
adjusting a distance between said side belt and a distal edge of said lower belt along a direction orthogonal to said group transport direction as a function of the predetermined width of product groups to be formed on the group conveyor.

7. The method of claim 6, comprising providing an actuator group configured to vary said distance and controlling said actuator group by a control unit configured to set said distance to a value corresponding to a predetermined width of the product groups to be formed on the group conveyor.

8. The method of claim 6, wherein said side belt is orthogonal to said lower belt.

9. The method of claim 6, wherein in a section orthogonal to said group transport direction said lower belt is inclined relative to a horizontal plane and wherein said proximal edge is lower than said distal edge.

10. The method of claim 6, comprising visually inspecting a part of the row of products on said input conveyor by a vision device, and controlling said first robotic unit based on information provided by said vision device.
